(19) United States
(12) Patent Application Publication
(10) Pub. No.: US 2024/0224161 A1
(43) Pub. Date: Jul. 4, 2024

(54) METHOD AND APPARATUS FOR MANAGING PUBLIC LAND MOBILE NETWORK SELECTION WITH AID OF NETWORK ALIVENESS VALIDATION

(71) Applicant: MEDIATEK INC., Hsinchu City (TW)

(72) Inventors: Shuang-An Chou, Hsinchu City (TW); Cheng-Hsiao Ko, Hsinchu City (TW); Yu-Hsiu Tseng, Hsinchu City (TW); Kuang-Ting Cheng, Hsinchu City (TW)

(73) Assignee: MADIATEK INC., Hsinchu City (TW)

(21) Appl. No.: 18/383,490

(22) Filed: Oct. 25, 2023

Related U.S. Application Data
(60) Provisional application No. 63/435,813, filed on Dec. 29, 2022.

(51) Int. Cl. H04W 48/10; H04W 48/18

(52) U.S. Cl. CPC H04W 48/10; H04W 48/18; H04W 84/042

(57) ABSTRACT

A method for managing public land mobile network (PLMN) selection of a user equipment (UE) includes: receiving system information broadcasted from a first PLMN on which the UE currently camps, wherein the system information is indicative of a disaster condition of the first PLMN; in response to receiving the system information, performing a network aliveness validation operation while the UE still camps on the first PLMN; and managing the PLMN selection of the UE according to a result of the network aliveness validation operation.

### CROSS REFERENCE TO RELATED APPLICATIONS

This application claims the benefit of U.S. Provisional Application No. 63/435,813, filed on Dec. 29, 2022. The content of the application is incorporated herein by reference.

### BACKGROUND

The present invention relates to wireless communications, and more particularly, to a method and apparatus for managing public land mobile network selection with aid of network aliveness validation.

A core network operator provides telecommunication services (e.g., voice and data services) to a user equipment (UE) through a communication network. One example of the communication network is a public land mobile network (PLMN) that includes a core network and one or more base stations (which collectively form an access network connected to the core network). A PLMN has a geographical coverage area in which the base station(s) provide voice and data services to mobile subscribers. Subscribers are identified and authenticated on the UE using a subscriber identification module (SIM)/universal subscriber identification module (USIM) card. When the UE is switched on or recovers from a lack of coverage, the UE needs to perform a PLMN selection process. In a PLMN selection process, the UE selects a PLMN, searches for a suitable cell of the selected PLMN, chooses that cell to provide available services to the UE, and monitors its control channel (aka “camps on the cell”). The UE then registers its presence in the tracking area of the chosen cell of the selected PLMN by performing a location update procedure.

The network may have a situation that makes infrastructure shut down, e.g., fire, earthquake, or power shut-down. Minimization of service interruption (MINT) concept is to find a PLMN which can be used for disaster roaming during a disaster condition. For example, the 5G system (5GS) provides a disaster roaming service (e.g., voice and data service) for a UE from a PLMN with disaster condition, where the disaster roaming information is broadcasted in a system information block (SIB) of a SIB type 15 (i.e., SIB15). Typically, when a cell of the PLMN broadcasts SIB15 that indicates the disaster condition, the UE directly leaves the PLMN. The UE still needs to search allowable PLMNs before camping on a cell that accepts disaster roaming from the PLMN with disaster condition. However, it is possible that the network has not been directly shut down and is still alive. Due to the fact that the UE still needs to search allowable PLMNs, the UE may select the original PLMN that broadcasts SIB15 to indicate disaster may be happening but is still alive.

Thus, there is a need for an innovative design which is capable of smartly detecting whether disaster is really happening to achieve minimization of service interruption under a situation that a PLMN broadcasts system information that is indicative of a disaster condition.

### SUMMARY

One of the objectives of the claimed invention is to provide a method and apparatus for managing public land mobile network selection with aid of network aliveness validation.

According to a first aspect of the present invention, an exemplary method for managing public land mobile network (PLMN) selection of a user equipment (UE) is disclosed. The exemplary method includes: receiving system information broadcasted from a first PLMN on which the UE currently camps, wherein the system information is indicative of a disaster condition of the first PLMN; in response to receiving the system information, performing a network aliveness validation operation while the UE still camps on the first PLMN; and managing the PLMN selection of the UE according to a result of the network aliveness validation operation.

According to a second aspect of the present invention, an exemplary user equipment (UE) is disclosed. The exemplary UE includes a wireless communication circuit and a control circuit. The wireless communication circuit is arranged to communicate with a first public land mobile network (PLMN) on which the UE currently camps. The control circuit is arranged to receive system information broadcasted from the first PLMN, wherein the system information is indicative of a disaster condition of the first PLMN; in response to receiving the system information, perform a network aliveness validation operation while the UE still camps on the first PLMN; and manage the PLMN selection of the UE according to a result of the network aliveness validation operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to an embodiment of the present invention.

FIG. 2 is flowchart illustrating a first network aliveness validation scheme according to an embodiment of the present invention.

FIG. 3 is flowchart illustrating a second network aliveness validation scheme according to an embodiment of the present invention.

FIG. 4 is flowchart illustrating a third network aliveness validation scheme according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

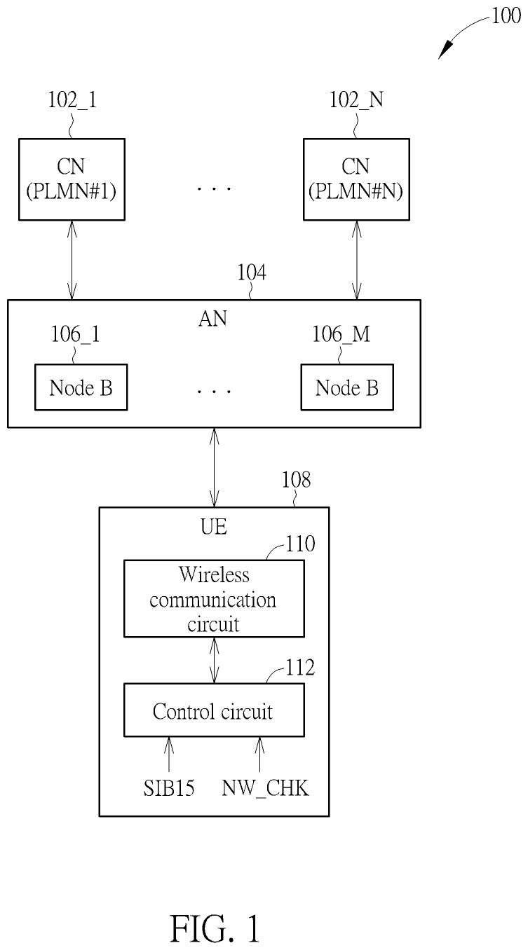

FIG. 1 is a diagram illustrating a wireless communication system according to an embodiment of the present invention. The wireless communication system 100 includes a plurality of core networks (CNs) 102_1-102_N (N≥2), an access network (AN) 104 including a plurality of base stations (labeled by “Node B”) 106_1-106_M (M≥2), and a user equipment (UE) 108. For example, the wireless communication system 100 may be a 5GS, each of CNs 102_1-102_N is a 5G core network (5GC), the AN 104 is a next-generation radio access network (NG-RAN), each of base stations 106_1-106_M is a next-generation Node B (gNB). In this embodiment, CNs 102_1-102_N are owned and operated by different operators, such that different PLMNs, including PLMN #1-PLMN #N, co-exist in the wireless communication system 100. The UE 108 may be a smartphone, and may perform a PLMN selection process to camp on a cell (e.g., an NG-RAN cell) of a selected PLMN, where the cell is served by one of the base stations 106_1-106_M that is connected to a CN of the selected PLMN. It should be noted that a same cell may belong to different PLMNs, and different cells in the same PLMN may have different disaster roaming allowance configurations.

In this embodiment, the UE 108 supports the proposed network aliveness validation scheme. As shown in FIG. 1, the UE 108 includes a wireless communication circuit 110 and a control circuit 112. It should be noted that only the components pertinent to the present invention are illustrated in FIG. 1. In practice, the UE 108 is allowed to include additional components to achieve other designated functions. The wireless communication circuit 110 includes hardware components required to deal with a transmit (TX) function and a receive (RX) function, and is arranged to communicate with a selected PLMN (e.g., one of PLMN #1-PLMN #N) on which the UE 108 currently camps. The control circuit 112 is responsible for managing the overall operation of the UE 108. For example, the control circuit 112 may perform and manage the proposed network aliveness validation scheme by using dedicated hardware. For another example, the control circuit 112 may perform and manage the proposed network aliveness validation scheme by using software running on a processor. In this embodiment, the control circuit 112 is arranged to receive system information SIB15 broadcasted from the serving PLMN, wherein the system information SIB15 is indicative of a disaster condition of the serving PLMN; in response to receiving the system information SIB15, perform a network aliveness validation operation NW_CHK while the UE 108 still camps on the serving PLMN (particularly, one cell of the serving PLMN); and manage the PLMN selection of the UE 108 according to a result of the network aliveness validation operation NW_CHK. Specifically, after receiving the system information SIB15 that is indicative of a disaster condition of the serving PLMN, the UE 108 stays on the serving PLMN and detects whether the serving PLMN is really out-of-service. Since the UE 108 does not directly leave the current camping PLMN upon receiving the system information SIB15 that indicates disaster may be happening, minimization of service interruption can be achieved under a condition that the result of the network aliveness validation operation NW_CHK keeps the UE 108 stayed on the current camping PLMN. Further details of the proposed network aliveness validation scheme are provided as below with reference to the accompanying drawings.

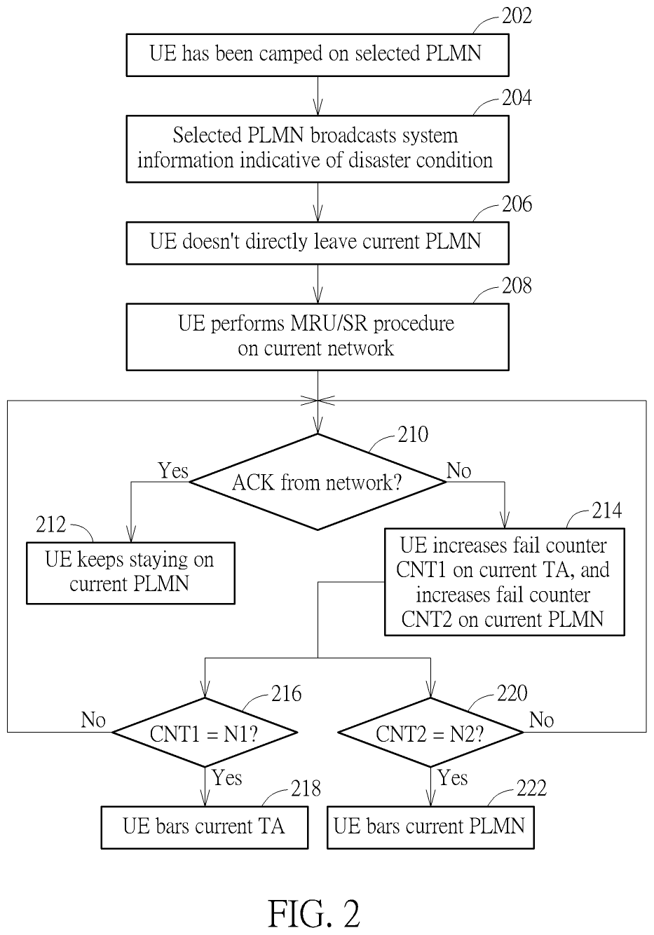

Please refer to FIG. 2 in conjunction with FIG. 1. FIG. 2 is flowchart illustrating a first network aliveness validation scheme according to an embodiment of the present invention. At step 202, the UE 108 has been camped on a selected PLMN (e.g., one of PLMN #1-PLMN #N). Hence, the selected PLMN is a current PLMN that is serving the UE 108. In the following, the terms “selected PLMN”, “current PLMN” and “serving PLMN” may be interchangeable. At step 204, the UE 108 receives system information SIB15 from the current PLMN, where the system information SIB15 is indicative of a disaster condition of the current PLMN. Specifically, the current PLMN broadcasts the system information SIB15 to indicate that disaster may be happening. At step 206, the UE 108 does not directly leave the current PLMN upon receiving the system information SIB15 from the current PLMN. At step 208, the UE 108 performs a non-access-stratum (NAS) procedure to verify a connection status between a base station and a core network that are related to the current PLMN of the UE 108. Specifically, in response to receiving the system information SIB15 indicative of disaster condition, the UE 108 sends NAS over-the-air (OTA) message(s) to the current network to verify a disaster situation between the base station and the core network. For example, the NAS procedure may be a mobility registration update (MRU) procedure. For another example, the NAS procedure may be a service request (SR) procedure. To put it simply, the UE 108 can smartly detect whether disaster is really happening by location update.

At step 210, the UE 108 checks if an acknowledgement (ACK) message is received before a timer of the NAS procedure expires. For example, the UE 108 performs an MRU procedure, and checks if the network responds before timeout of the procedure timer T3510. For another example, the UE 108 performs an SR procedure, and checks if the network responds before timeout of the procedure timer T3517. If an ACK message is received before the timer of the NAS procedure expires, the UE 108 determines that the current PLMN is still alive, and thus keeps staying on the current PLMN. If no ACK message is received before the timer of the NAS procedure expires, the UE 108 increases a fail counter CNT1 on the current tracking area (TA), and increases a fail counter CNT2 on the current PLMN, where the UE 108 currently camps on a cell being one of cells included in the current TA, and the current TA is one of TAs included in the current PLMN. At step 216, the UE 108 checks if the fail counter CNT1 reaches a predetermined threshold N1 (N1≥1). If the fail counter CNT1 reaches the predetermined threshold N1, the UE 108 bars the current TA (step 218). At step 220, the UE 108 checks if the fail counter CNT2 reaches a predetermined threshold N2 (N2≥1). If the fail counter CNT2 reaches the predetermined threshold N2, the UE 108 bars the current PLMN.

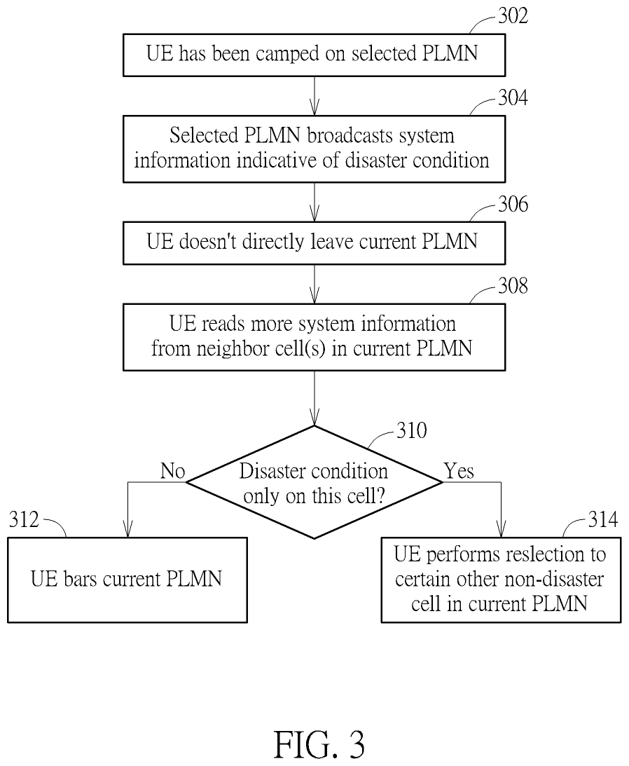

Please refer to FIG. 3 in conjunction with FIG. 1. FIG. 3 is flowchart illustrating a second network aliveness validation scheme according to an embodiment of the present invention. At step 302, the UE 108 has been camped on a selected PLMN (e.g., one of PLMN #1-PLMN #N). Hence, the selected PLMN is a current PLMN that is serving the UE 108. In the following, the terms “selected PLMN”, “current PLMN” and “serving PLMN” may be interchangeable. At step 304, the UE 108 receives system information SIB15 from the current PLMN, where the system information SIB15 is indicative of a disaster condition of the current PLMN. Specifically, the current PLMN broadcasts the system information SIB15 to indicate that disaster may be happening. At step 306, the UE 108 does not directly leave the current PLMN upon receiving the system information SIB15 from the current PLMN. At step 308, the UE 108 receives system information broadcasted from neighbor cell(s) also included in the current PLMN that the UE 108 currently camps on, for checking if the same disaster condition occurs on more than one cell in the current PLMN. At step 310, the UE 108 checks if the disaster condition is only on this cell that the UE 108 currently camps on. If the disaster condition occurs on more than one cell in the current PLMN, the UE 108 bars the current PLMN (step 312). If the disaster condition is only on this cell that the UE 108 currently camps on, the US 108 performs reselection to certain other non-disaster cell in the current PLMN to keep minimization of service interruption, and may bar the original cell during a certain period of time (step 314).

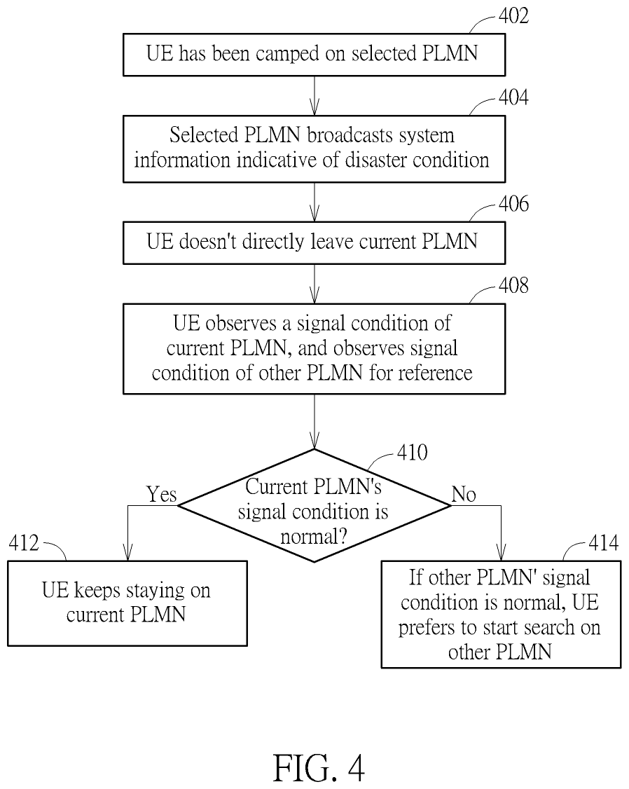

Please refer to FIG. 4 in conjunction with FIG. 1. FIG. 4 is flowchart illustrating a third network aliveness validation scheme according to an embodiment of the present invention. At step 402, the UE 108 has been camped on a selected PLMN (e.g., one of PLMN #1-PLMN #N). Hence, the selected PLMN is a current PLMN that is serving the UE 108. In the following, the terms “selected PLMN”, “current PLMN” and “serving PLMN” may be interchangeable. At step 404, the UE 108 receives system information SIB15 from the current PLMN, where the system information SIB15 is indicative of a disaster condition of the current PLMN. Specifically, the current PLMN broadcasts the system information SIB15 to indicate that disaster may be happening. At step 406, the UE 108 does not directly leave the current PLMN upon receiving the system information SIB15 from the current PLMN. At step 408, the UE 108 observes a signal condition of the current PLMN that the UE 108 currently camps on, and also observes a signal condition of at least one other PLMN for reference. At step 410, the UE 108 checks if current PLMN's signal condition is normal. For example, the UE 108 determines that one PLMN's signal condition is abnormal if one or more of the following conditions are met, including cell search but not found, Cyclic Redundancy Check (CRC) NG on same cell when receiving SIBs, Radio Link Failure (RLF) or Random Access (RA) error in Radio Resource Control (RRC) connected mode, unexpected connection release, and unexpected connection reject. If current PLMN's signal condition is normal, the UE 108 keeps staying on the current PLMN (step 412). If the current PLMN's signal condition is abnormal and other PLMN's signal condition is normal, the UE 108 prefers to start search on other PLMN for selecting a suitable cell to camp on (step 414).

In summary, the proposed network aliveness validation scheme of the present invention makes the UE still stay on the current PLMN when system information broadcasted from the current PLMN indicates that disaster may be happening, and detects the actual disaster situation to determine whether the UE can keep staying on the current PLMN. If the actual disaster situation checked by the proposed network aliveness validation scheme indicates that the UE can keep staying on the current PLMN, minimization of the interruption of service can be maintained due to the fact that the UE continuously stays on the current PLMN since the current PLMN broadcasts system information to indicate that disaster may be happening.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing public land mobile network (PLMN) selection of a user equipment (UE), comprising:
receiving system information broadcasted from a first PLMN on which the UE currently camps, wherein the system information is indicative of a disaster condition of the first PLMN;
in response to receiving the system information, performing a network aliveness validation operation while the UE still camps on the first PLMN; and
managing the PLMN selection of the UE according to a result of the network aliveness validation operation.

2. The method of claim 1, wherein the network aliveness validation operation comprises:
performing a non-access-stratum (NAS) procedure to verify a connection status between a base station and a core network that are related to the first PLMN.

3. The method of claim 2, wherein managing the PLMN selection of the UE according to the result of the network aliveness validation operation comprises:
in response to determining that an acknowledgement message is received before a timer of the NAS procedure expires, keeping the UE stayed on the first PLMN.

4. The method of claim 2, wherein the network aliveness validation operation further comprises:
in response to determining that no acknowledgement message is received before a timer of the NAS procedure expires, increasing a fail counter on a current tracking area (TA) of the first PLMN, where the UE camps on a cell included in the current TA.

5. The method of claim 4, wherein managing the PLMN selection of the UE according to the result of the network aliveness validation operation comprises:
in response to determining that the fail counter reaches a predetermined threshold, barring the current TA.

6. The method of claim 2, wherein the network aliveness validation operation further comprises:
in response to determining that no acknowledgement message is received before a timer of the NAS procedure expires, increasing a fail counter on the first PLMN.

7. The method of claim 6, wherein managing the PLMN selection of the UE according to the result of the network aliveness validation operation comprises:
in response to determining that the fail counter reaches a predetermined threshold, barring the first PLMN.

8. The method of claim 2, wherein the NAS procedure is a mobility registration update (MRU) procedure.

9. The method of claim 2, wherein the NAS procedure is a service request (SR) procedure.

10. The method of claim 1, wherein the first PLMN comprises a plurality cells, the plurality cells comprise a first cell and at least one second cell, the UE currently camps on the first cell, the system information is broadcasted from the first cell of the first PLMN, and the network aliveness validation operation comprises:
receiving system information broadcasted from the at least one second cell; and
comparing the system information broadcasted from the first cell and the system information broadcasted from the at least one second cell.

11. The method of claim 10, wherein managing the PLMN selection of the UE according to the result of the network aliveness validation operation comprises:
in response to determining that the system information broadcasted from the at least one second cell is not indicative of a disaster condition, doing reselection to one of the plurality of cells that is different from the first cell.

12. The method of claim 1, wherein the network aliveness validation operation comprises:
observing a signal condition of the first PLMN.

13. The method of claim 12, wherein managing the PLMN selection of the UE according to the result of the network aliveness validation operation comprises:
in response to determining that the signal condition of the first PLMN is normal, keeping the UE stayed on the first PLMN.

14. The method of claim 12, wherein the network aliveness validation operation comprises:
observing a signal condition of at least one second PLMN different from the first PLMN.

15. The method of claim 14, wherein managing the PLMN selection of the UE according to the result of the network aliveness validation operation comprises:
in response to determining that the signal condition of the first PLMN is abnormal and the signal condition of the at least one second PLMN is normal, starting to search on the at least one second PLMN.

16. A user equipment (UE) comprising:
a wireless communication circuit, arranged to communicate with a first public land mobile network (PLMN) on which the UE currently camps; and
a control circuit, arranged to receive system information broadcasted from the first PLMN, wherein the system information is indicative of a disaster condition of the first PLMN; in response to receiving the system information, perform a network aliveness validation operation while the UE still camps on the first PLMN; and manage the PLMN selection of the UE according to a result of the network aliveness validation operation.

17. The UE of claim 16, wherein the network aliveness validation operation comprises:
performing a non-access-stratum (NAS) procedure to verify a connection status between a base station and a core network that are related to the first PLMN.

18. The UE of claim 17, wherein the NAS procedure is one of a mobility registration update (MRU) procedure and a service request (SR) procedure.

19. The UE of claim 16, wherein the first PLMN comprises a plurality cells, the plurality cells comprise a first cell and at least one second cell, the UE currently camps on the first cell, the system information is broadcasted from the first cell of the first PLMN, and the network aliveness validation operation comprises:
receiving system information broadcasted from the at least one second cell; and
comparing the system information broadcasted from the first cell and the system information broadcasted from the at least one second cell.

20. The UE of claim 16, wherein the network aliveness validation operation comprises:
observing a signal condition of the first PLMN.
